(19) United States
(12) Patent Application Publication
(10) Pub. No.: US 2019/0232724 A1
(43) Pub. Date: Aug. 1, 2019

(54) PNEUMATIC TIRE

(71) Applicant: Toyo Tire Corporation, Itami-shi (JP)

(72) Inventor: Sachio Sakamoto, Itami-shi (JP)

(73) Assignee: Toyo Tire Corporation, Itami-shi, Hyogo (JP)

(21) Appl. No.: 16/253,531

(22) Filed: Jan. 22, 2019

(30) Foreign Application Priority Data
Jan. 31, 2018 (JP) 2018-015807

(51) Int. Cl. B60C 11/03; B60C 11/00; B60C 11/04; B60C 5/00

(52) U.S. Cl. CPC B60C 11/0332; B60C 11/0083; B60C 2011/0341; B60C 11/04; B60C 5/00; B60C 11/0318

(57) ABSTRACT

A pneumatic tire comprises a plurality of main grooves extending in a tire circumferential direction, and a plurality of land portions that are partitioned by at least one contact patch end and the plurality of main grooves, the plurality of land portions comprise a center land portion that contains a center in a tire width direction, and a pair of side land portions that are adjacent in the tire width direction to the center land portion, and respective maximum values of amounts by which the pair of side land portions protrude from a tread profile are each greater than a maximum value of an amount by which the center land portion protrudes from the tread profile.

### CROSS REFERENCE TO RELATED APPLICATIONS

This application claims the benefit of priority of Japanese application no. 2018-15807, filed on Jan. 31, 2018, which is incorporated herein by reference.

### BACKGROUND OF THE INVENTION

### Field of the Invention

The present invention relates to a pneumatic tire.

### Description of the Related Art

Conventionally a pneumatic tire might, for example, comprise a plurality of main grooves extending along the tire circumferential direction, and a plurality of land portions which are partitioned by contact patch ends and the plurality of main grooves. In addition, the land portions may be formed in such fashion as to protrude from the tread profile (e.g., JP-A 2017-30635, JP-A 2017-65285, JP-A 2015-182680, JP-A 2012-106608, and JP-A 2017-105361).

It so happens that, due to the amounts by which the land portions protrude from the tread profile, there are situations in which contact patch pressure becomes nonuniform in the tire width direction. For example, there are situations in which contact patch pressure becomes nonuniform in the tire width direction due to an increase in the difference between the contact patch pressure at the center in the tire width direction and the contact patch pressure toward the exterior in the tire width direction.

### SUMMARY OF THE INVENTION

The problem is therefore to provide a pneumatic tire that will make it possible for contact patch pressure to be made uniform in the tire width direction.

There is provided a pneumatic tire comprises:

a plurality of main grooves extending in a tire circumferential direction; and

a plurality of land portions that are partitioned by at least one contact patch end and the plurality of main grooves;

wherein the plurality of land portions comprise a center land portion that contains a center in a tire width direction, and a pair of side land portions that are adjacent in the tire width direction to the center land portion; and

wherein respective maximum values of amounts by which the pair of side land portions protrude from a tread profile are each greater than a maximum value of an amount by which the center land portion protrudes from the tread profile.

Further, the pneumatic tire may have a configuration in which:

respective average values of the amounts by which the side land portions protrude are each greater than an average value of the amount by which the center land portion protrudes.

Further, the pneumatic tire may have a configuration in which:

a void fraction of the center land portion is greater than respective void fractions of each of the side land portions.

Further, the pneumatic tire may have a configuration in which:

the amount by which at least one of the side land portions protrudes decreases as one proceeds from a location intermediate in the tire width direction of the at least one side land portion toward either end in the tire width direction of the at least one side land portion.

Further, the pneumatic tire may have a configuration in which:

at least one of the side land portions comprises a protruding region that protrudes from the tread profile;

the protruding region comprises a peak at which an amount of protrusion from the tread profile is a maximum;

at least one side land portion is divided in the tire width direction into three equal regions including a central region; and

the peak is arranged in the central region.

Further, the pneumatic tire may have a configuration in which:

a dimension in the tire width direction of each of the side land portions is less than a dimension in the tire width direction of the center land portion.

Further, the pneumatic tire may have a configuration in which:

there are four of the main grooves;

the plurality of land portions comprise a pair of shoulder land portions arranged in outwardmost fashion in the tire width direction; and

a maximum value of an amounts by which each of the pair of side land portions protrudes from the tread profile is greater than a maximum value of an amount by which each of the pair of shoulder land portions protrudes from the tread profile.

Further, the pneumatic tire may have a configuration in which:

a dimension in the tire width direction of each of the side land portions is less than a dimension in the tire width direction of each of the shoulder land portions.

### BRIEF DESCRIPTION OF DRAWINGS

FIG. 1 is a view of a section, taken along a tire meridional plane, of the principal components in a pneumatic tire associated with an embodiment;

FIG. 2 is a drawing showing a tread surface of a pneumatic tire associated with same embodiment as they would exist if unwrapped so as to lie in a single plane;

FIG. 3 is a schematic cross-sectional view, taken along a tire meridional plane, of the principal components in a pneumatic tire associated with same embodiment;

FIG. 4 is a drawing showing a tread surface associated with a modified example as they would exist if unwrapped so as to lie in a single plane;

FIG. 5 is a view of a section, taken along a tire meridional plane, of the principal components in a tread region associated with another modified example;

FIG. 6 is a view of a section, taken along a tire meridional plane, of the principal components in a tread region associated with same embodiment;

FIG. 7 is a drawing showing the surface shape that comes in contact with the road surface at a pneumatic tire associated with a comparative example;

FIG. 8 is a drawing showing the surface shape that comes in contact with the road surface at a pneumatic tire associated with FIG. 1 through FIG. 3 and FIG. 6; and

FIG. 9 is a view of a section, taken along a tire meridional plane, of the principal components in a tread region associated with another embodiment.

### DETAILED DESCRIPTION OF THE INVENTION

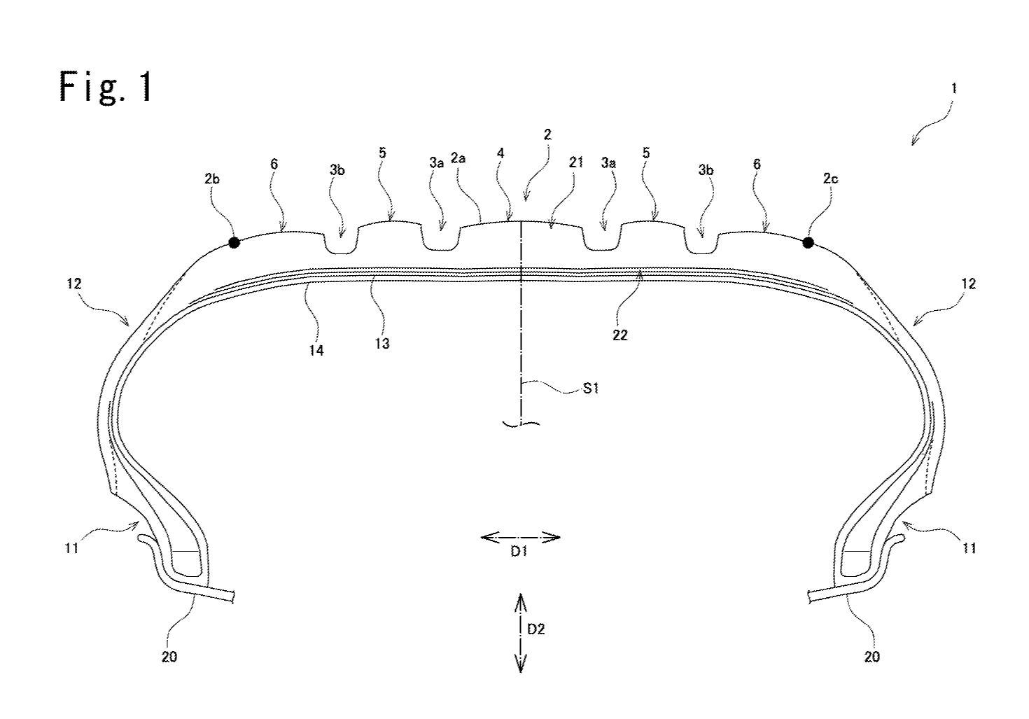

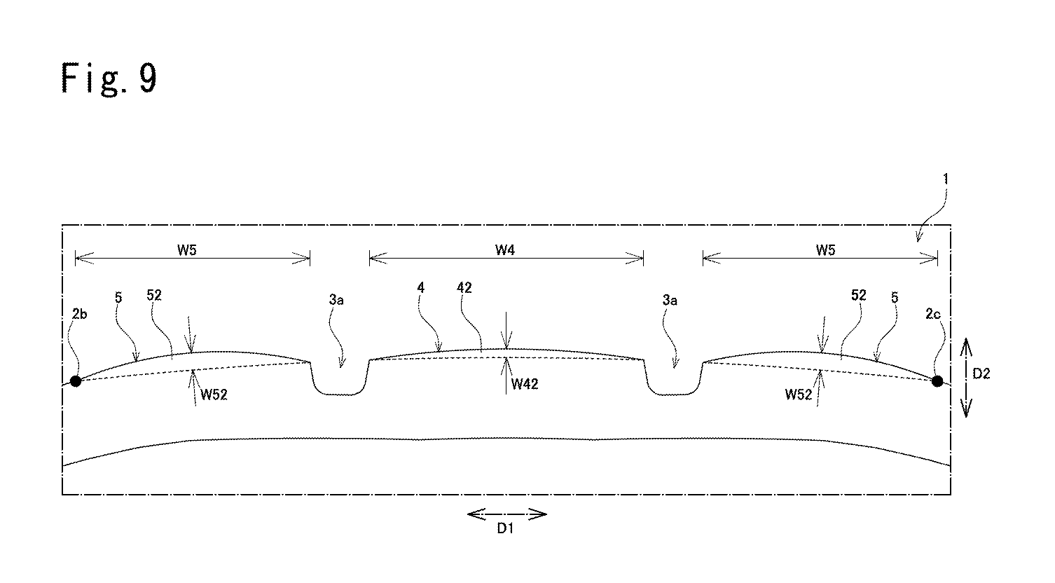

Below, an embodiment of a pneumatic tire is described with reference to FIG. 1 through FIG. 8. At the respective drawings (and the same is true for FIG. 9), note that dimensional ratios at the drawings and actual dimensional ratios are not necessarily consistent, and note further that dimensional ratios are not necessarily consistent from drawing to drawing.

At the respective drawings, first direction D1 is the tire width direction D1 which is parallel to the tire rotational axis which is the center of rotation of pneumatic tire (hereinafter also referred to as simply “tire”) 1, second direction D2 is the tire radial direction D2 which is the direction of the diameter of tire 1, and third direction D3 is the tire circumferential direction D3 which is circumferential with respect to the rotational axis of the tire.

Tire equatorial plane S1 refers to a plane that is located centrally in the tire width direction D1 of tire 1 and that is perpendicular to the rotational axis of the tire; tire meridional planes refer to planes that are perpendicular to tire equatorial plane S1 and that contain the rotational axis of the tire. Furthermore, the tire equator is the curve formed by the intersection of tire equatorial plane S1 and the outer surface (tread surface 2a, described below) in the tire radial direction D2 of tire 1.

As shown in FIG. 1, tire 1 associated with the present embodiment is provided with a pair of bead regions 11 at which beads are present; sidewall regions 12 which extend outwardly in the tire radial direction D2 from the respective bead regions 11; and tread region 2, the exterior surface in the tire radial direction D2 of which contacts the road surface and which is contiguous with the outer ends in the tire radial direction D2 of the pair of sidewall regions 12. In accordance with the present embodiment, tire 1 is a pneumatic tire 1, the interior of which is capable of being filled with air, and which is capable of being mounted on a rim 20.

Furthermore, tire 1 is provided with carcass layer 13 which spans the pair of beads, and innerliner layer 14 which is arranged at a location toward the interior from carcass layer 13 and which has superior functionality in terms of its ability to impede passage of gas therethrough so as to permit air pressure to be maintained. Carcass layer 13 and innerliner layer 14 are arranged in parallel fashion with respect to the inner circumferential surface of the tire over a portion thereof that encompasses bead regions 11, sidewall regions 12, and tread region 2.

Tread region 2 is provided with tread rubber 21 having tread surface 2a which contacts the road surface, and belt region 22 which is arranged between tread rubber 21 and carcass layer 13. Present at tread surface 2a is the contact patch that actually comes in contact with the road surface, and the portions within said contact patch that are present at the outer ends in the tire width direction D1 are referred to as contact patch ends 2b, 2c. Note that said contact patch refers to the portion of the tread surface 2a that comes in contact with the road surface when a normal load is applied to a tire 1 mounted on a normal rim 20 when the tire 1 is inflated to normal internal pressure and is placed in vertical orientation on a flat road surface.

Normal rim 20 is that particular rim 20 which is specified for use with a particular tire 1 in the context of the body of standards that contains the standard that applies to the tire 1 in question, this being referred to, for example, as a standard rim in the case of JATMA, a “Design Rim” in the case of IRA, or a “Measuring Rim” in the case of ETRTO.

Normal internal pressure is that air pressure which is specified for use with a particular tire 1 in the context of the body of standards that contains the standard that applies to the tire 1 in question, this being maximum air pressure in the case of JATMA, the maximum value listed at the table entitled “TIRE LOAD LIMITS AT VARIOUS COLD INFLATION PRESSURES” in the case of TRA, or “INFLATION PRESSURE” in the case of ETRTO, which when tire 1 is to used on a passenger vehicle is taken to be an internal pressure of 180 KPa.

Normal load is that load which is specified for use with a particular tire 1 in the context of the body of standards that contains the standard that applies to the tire 1 in question, this being maximum load capacity in the case of JATMA, the maximum value listed at the aforementioned table in the case of TRA, or “LOAD CAPACITY” in the case of ETRTO, which when tire 1 is to be used on a passenger vehicle is taken to be 85% of the load corresponding to an internal pressure of 180 KPa.

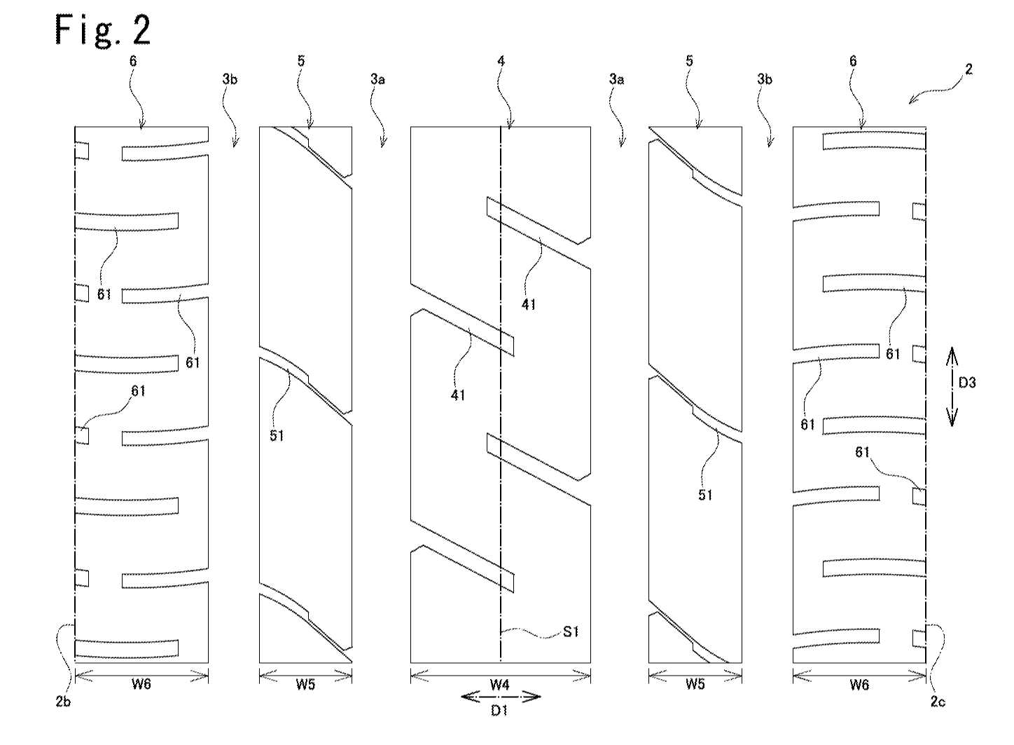

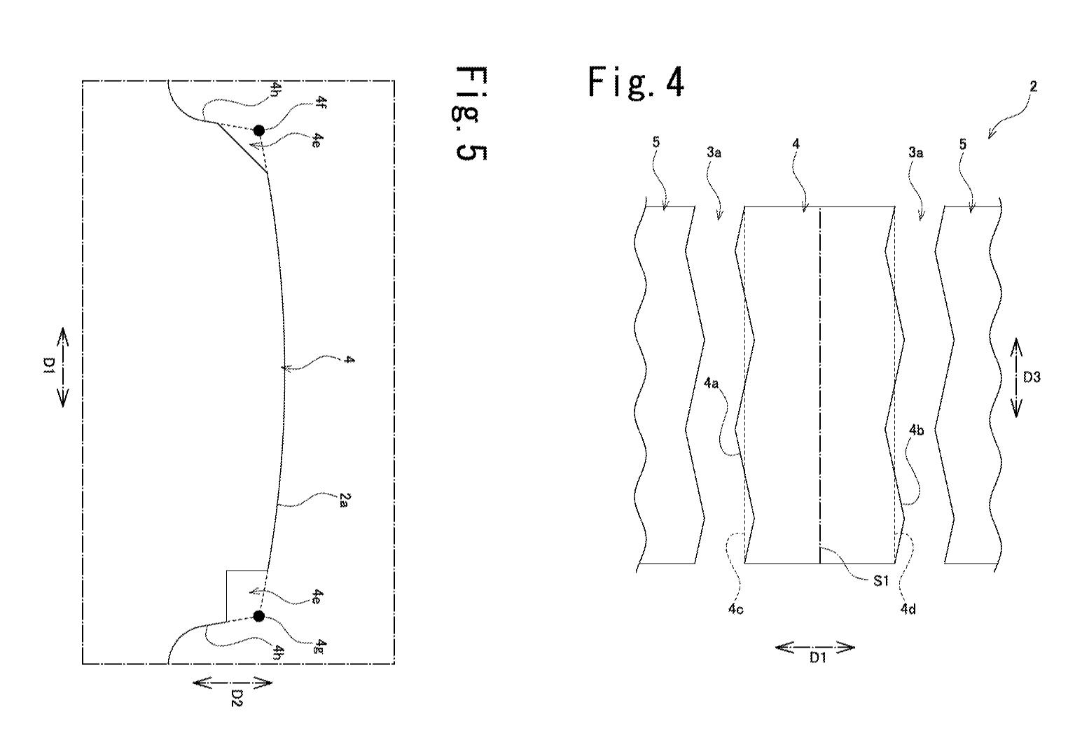

As shown in FIG. 1 and FIG. 2, tread rubber 21 is provided with a plurality of main grooves 3a, 3b extending in the tire circumferential direction D3. Main groove 3a, 3b extends continuously in the tire circumferential direction D3. Note that whereas main grooves 3a, 3b extend in straight fashion in the tire circumferential direction D3 in the present embodiment, there is no limitation with respect to such constitution, it also being possible to adopt a constitution in which these are, for example, repeatedly bent such that they extend in zigzag fashion (see FIG. 4), or a constitution in which these are, for example, repeatedly curved such that they extend in wavy fashion.

Main groove 3a, 3b might, for example, be provided with so-called tread wear indicator(s) (not shown) which are portions at which depth of the groove is reduced so as to make it possible to ascertain the extent to which wear has occurred as a result of the exposure thereof that takes place in accompaniment to wear. Furthermore, main groove 3a, 3b might, for example, have a width that is not less than 3% of the distance (dimension in the tire width direction D1) between contact patch ends 2b, 2c. Furthermore, main groove 3a, 3b might, for example, have a width that is not less than 5 mm.

All of the main grooves 3a, 3b are separated from tire equatorial plane S1. In addition, at the plurality of main grooves 3a, 3b, the pair of main grooves 3a, 3a arranged so as to straddle tire equatorial plane S1 which is at the center in the tire width direction D1 of tire 1 are referred to as center main grooves 3a, 3a; and main groove (s) 3b arranged toward the exterior in the tire width direction D1 from center main groove(s) 3a are referred to as shoulder main groove(s) 3b.

Tread rubber 21 comprises a plurality of land portions 4 through 6 which are partitioned by main groove 3a, 3b and contact patch ends 2b, 2c. At the plurality of land portions 4 through 6, land portion 4 containing the tire equatorial plane S1 which is at the center in the tire width direction D1 is referred to as center land portion 4; the pair of land portions 5, 5 which are adjacent in the tire width direction D1 to center land portion 4 are referred to as side land portions 5, 5; and the pair of land portions 6, 6 arranged in outwardmost fashion in the tire width direction D1 are referred to as shoulder land portions 6, 6.

Center land portion 4 is partitioned by the pair of center main grooves 3a, 3a that are arranged so as to straddle tire equatorial plane S1 which is at the center in the tire width direction D1. Side land portion 5 is partitioned by center main groove 3a and shoulder main groove 3b. Shoulder land portion 6 is partitioned by shoulder main groove 3b and contact patch end 2b, 2c.

Land portions 4 through 6 comprise a plurality of land grooves 41, 51, 61. In accordance with the present embodiment, land grooves 41, 51, 61 are grooves (also referred to as “width grooves”) that extend in such fashion as to intersect the tire circumferential direction D3. Note that land groove(s) may include groove(s) (also referred to as “circumferential groove(s)”) that are narrower than main groove(s) 3a, 3b and that extend continuously along the tire circumferential direction D3, and/or groove(s) that extend intermittently along the tire circumferential direction D3.

Tread rubber 21 comprises a tread pattern formed by main groove 3a, 3b and land grooves 41, 51, 61. In accordance with the present embodiment, tire 1 employs a symmetric tread pattern for which no vehicle mounting orientation is indicated. The tread pattern at FIG. 2 is a tread pattern that exhibits point symmetry about an arbitrary point on the tire equator.

As a symmetric tread pattern for which no vehicle mounting orientation is indicated, note that tire 1 may employ a line-symmetric tread pattern exhibiting symmetry about the tire equator. Furthermore, tire 1 may employ an asymmetric tread pattern for which a vehicle mounting orientation is indicated. Note that a tire 1 for which a vehicle mounting orientation is indicated may comprise, e.g., at sidewall region 12, an indicator region that indicates an orientation in which the tire is to be mounted on the vehicle.

Dimension W5 in the tire width direction D1 of side land portion 5 is less than dimension W4 in the tire width direction D1 of center land portion 4. Note that there is no particular limitation with regard to dimension W6 in the tire width direction D1 of shoulder land portion 6. For example, at FIG. 2, dimension W6 in the tire width direction D1 of shoulder land portion 6 is greater than dimension W5 in the tire width direction D1 of side land portion 5 but is less than dimension W4 in the tire width direction D1 of center land portion 4.

Furthermore, the void fraction at center land portion 4 is greater than the void fraction at side land portion(s) 5. As a result, because the void fraction at center land portion 4 will be high, rigidity of center land portion 4 will be low. Note that void fraction is the ratio of the total area of land groove(s) 41, 51 to the area of land portion 4, 5 (including land groove(s) 41, 51).

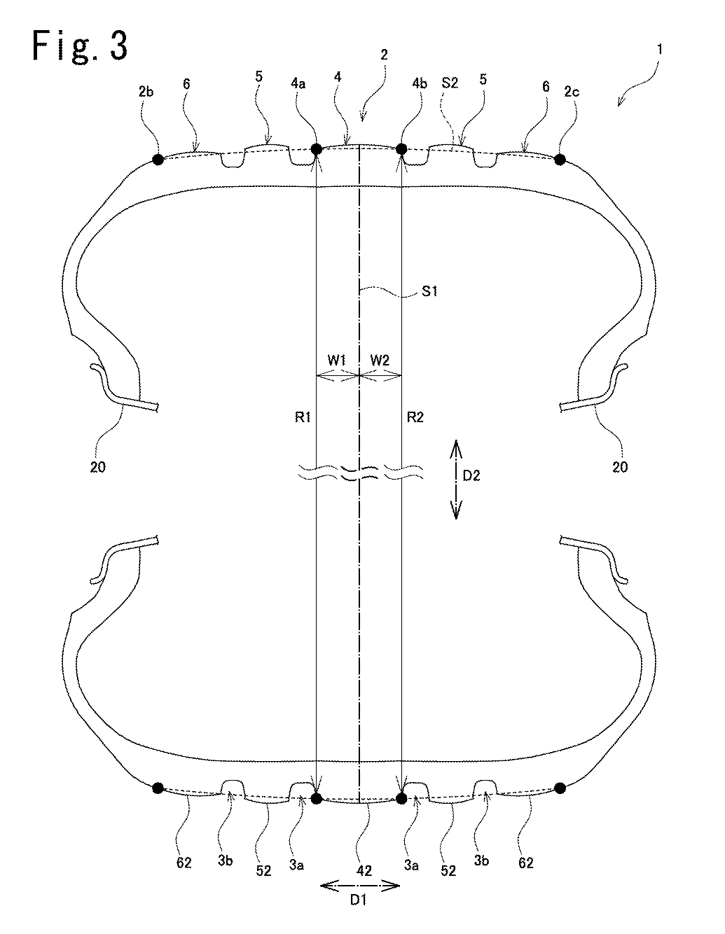

The constitutions of land portions 4 through 6 will now be described with reference to FIG. 3 through FIG. 6.

As shown in FIG. 3, tread profile S2 which serves as tire reference outline is present toward the outside surface in the tire radial direction D2 of tread region 2. As viewed in a tire meridional section, tread profile S2 is curved in such fashion as to present a convex appearance to the exterior in the tire radial direction D2. Tread profile S2 may be defined as that single circular arc which when tire 1 mounted on normal rim 20 and inflated to normal internal pressure under no load is viewed in a tire meridional section (section along the tire radial direction D2) contains the three points constituted by the pair of contact patch ends 2b, 2c and reference end edge 4a (4b) of center land portion 4.

Note that reference end edge 4a (4b) of center land portion 4 is that end edge 4a (4b) for which, of the pair of end edges 4a, 4b in the tire width direction D1 of center land portion 4, the distance W1, W2 between it and the center (tire equatorial plane S1) in the tire width direction D1 is less than that of the other. Furthermore, in the event that said distances W1, W2 are the same, reference end edge 4a (4b) of center land portion 4 is that end edge 4a (4b) for which the tire outside diameter R1, R2 is less than that of the other.

Furthermore, as shown in FIG. 4, in the context of a configuration in which center main groove 3a extends in zigzag-like fashion, reference end edge 4c (4d) of center land portion 4 is the equivalent end edge 4c (4d). Note that equivalent end edge 4c, 4d may be determined based on the average location in the tire width direction D1 of end edge 4a, 4b.

Furthermore, as shown in FIG. 5, in the context of a configuration in which center land portion 4 comprises notch(es) 4e at the ends thereof, reference end edge 4f (4g) of center land portion 4 is the equivalent end edge 4f (4g). Note that equivalent end edge 4f, 4g may be determined based on the intersection of the imaginary line (shown in broken line at FIG. 5) which is the extension of tread surface 2a of center land portion 4 and the imaginary line (shown in broken line at FIG. 5) which is the extension of end face 4h to one (or the other) side in the tire width direction D1 of center land portion 4.

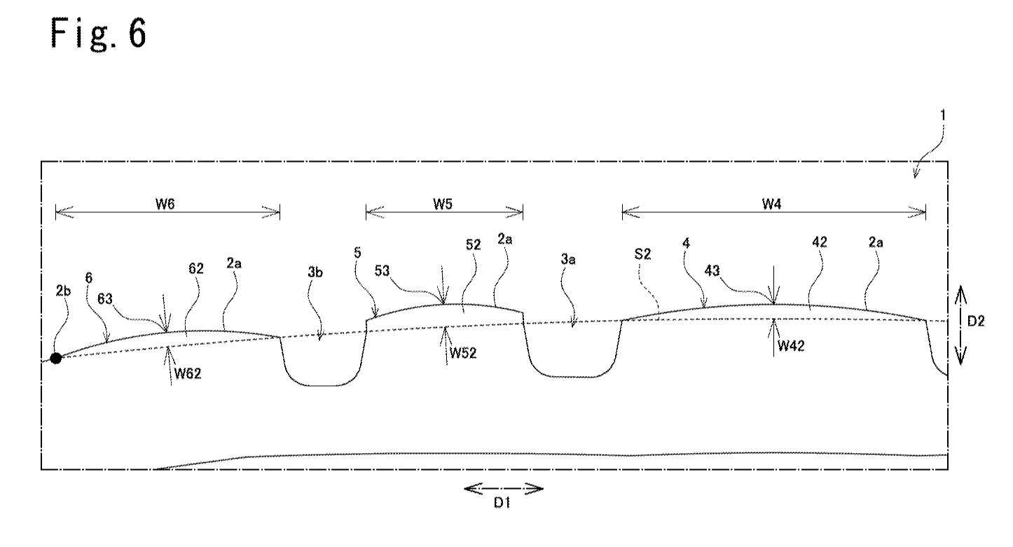

As shown in FIG. 6, tread surfaces 2a of all land portions 4 through 6 are located toward the exterior in the tire radial direction D2 from tread profile S2. That is, each land portion through 6 comprises a protruding region 42, 52, 62 (hereinafter sometimes written as “42 through 62”) that protrudes toward the exterior in the tire radial direction D2 from tread profile S2. At the respective drawings, note that protruding regions 42 through 62 are drawn in exaggerated fashion.

The maximum value of the amount W52 by which protruding region (hereinafter also referred to as “side protruding region”) 52 of side land portion 5 protrudes is greater than the maximum value of the amount W42 by which protruding region (hereinafter also referred to as “central protruding region”) 42 of center land portion 4 protrudes. It is, for example, preferred that the maximum values of protruding amounts W42 through W62 of respective protruding regions 42 through 62 be 0.1 mm to 0.5 mm.

Note that there is no particular limitation with regard to the maximum value of the amount W62 by which protruding region (hereinafter also referred to as “shoulder protruding region”) 62 of shoulder land portion 6 protrudes. For example, at FIG. 6, the maximum value of the amount W62 by which shoulder protruding region 62 protrudes is less than the maximum value of the amount W52 by which side protruding region 52 protrudes but is the same as the maximum value of the amount W42 by which central protruding region 42 protrudes.

Here, protruding amounts W42 through W62 refer to the amount of protrusion, in a direction normal to tread profile S2, from tread profile S2. Note that where a tread surface 2a at land portions 4 through 6 is recessed relative to tread profile S2, the protruding amount W42 through W62 of that recessed region will be a negative protruding amount. For example, where a recessed region is recessed by 0.3 mm relative to tread profile S2 (the recessed amount is 0.3 mm), the protruding amount thereof will be −0.3 mm.

In addition, the average value of the amount W52 by which side protruding region 52 protrudes is greater than the average value of the amount W42 by which central protruding region 42 protrudes. More specifically, as viewed in a tire meridional section, the ratio of the area of side protruding region 52 to dimension W5 in the tire width direction D1 of side land portion 5 is greater than the ratio of the area of central protruding region 42 to dimension W4 in the tire width direction D1 of center land portion 4.

Furthermore, as viewed in a tire meridional section, tread surfaces 2a of land portions 4 through 6 are formed so as to be curved in such fashion as to present a convex appearance to the exterior in the tire radial direction D2. This being the case, the locations at tread surfaces 2a at which protruding amounts W42 through W62 of protruding regions 42 through 62 are maxima, i.e., peaks 43 through 63 of protruding regions 42 through 62, will be arranged at locations intermediate in the tire width direction D1 within land portions 4 through 6.

In addition, protruding amounts W42 through W62 of protruding regions 42 through 62 decrease as one proceeds from peaks 43 through 63 toward the ends in the tire width direction D1 of land portions 4 through 6. Moreover, as viewed in a tire meridional section, it is, for example, preferred that the radii of curvature of tread surfaces 2a of land portions 4 through 6 be 100 mm to 5000 mm.

Moreover, in accordance with the present embodiment, neither center land portion 4 nor side land portion 5 comprise a notch (see FIG. 5) at either end thereof in the tire width direction D1. Nor does shoulder land portion 6 comprise a notch (see FIG. 5) at the end thereof toward the interior in the tire width direction D1.

Constitution of tire 1 associated with the present embodiment is as described above; action of tire 1 associated with the present embodiment is described below.

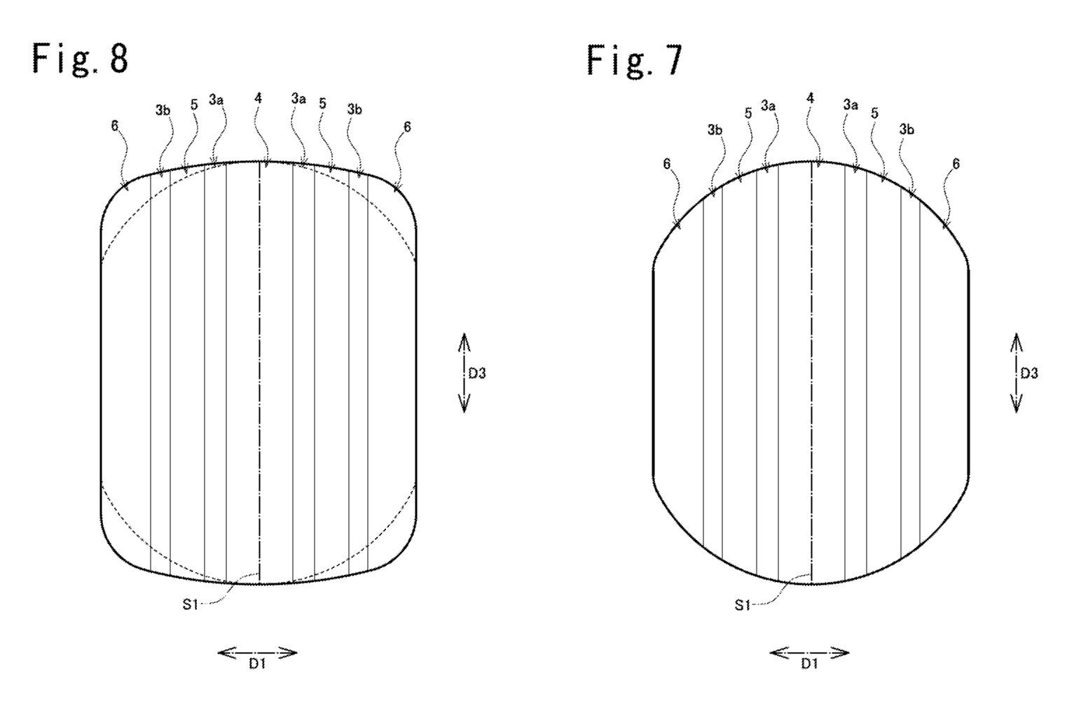

For example, FIG. 7 shows the surface shape that comes in contact with the road surface at a tire associated with a comparative embodiment (note that land grooves 41 through 61 are not shown at FIG. 7 (and the same is true for FIG. 8)). Note that, unlike tire 1 associated with the present embodiment, the tire associated with the comparative embodiment is a tire at which tread surfaces 2a of land portions 4 through 6 are coincident with tread profile S2.

Accordingly, because at the tire associated with the comparative embodiment there will be a large difference between the tire outside diameter at center land portion 4 and the tire outside diameter at side land portion 5, the surface shape that comes in contact with the road surface produced thereby will as shown in FIG. 7 be such that there is a large difference between the contact patch length at center land portion 4 and the contact patch length at side land portion 5. As a result, because there will be a large difference between the contact patch pressure at center land portion 4 and the contact patch pressure at side land portion 5, contact patch pressure will be nonuniform in the tire width direction D1.

In contradistinction with respect thereto, tire 1 in accordance with the present embodiment is such that the maximum value of the amount W52 by which side protruding region 52 protrudes is greater than the maximum value of the amount W42 by which central protruding region 42 protrudes, and is such that the average value of the amount W52 by which side protruding region 52 protrudes is greater than the average value of the amount W42 by which central protruding region 42 protrudes. As a result, because this causes the difference between the tire outside diameter at center land portion 4 and the tire outside diameter at side land portion 5 to decrease, this causes the difference between the contact patch length at center land portion 4 and the contact patch length at side land portion 5 to decrease.

What is more, because the void fraction at center land portion 4 is greater than the void fraction at side land portion 5, rigidity of center land portion 4 will be low. As a result, because center land portion 4 more readily undergoes compressive deformation in the tire radial direction D2, side land portion 5 will more readily make contact with the road surface. Accordingly, the difference between the contact patch length at center land portion 4 and the contact patch length at side land portion 5 will decrease even further.

As a result, as shown in FIG. 8, the surface shape that comes in contact with the road surface at the tire 1 associated with the present embodiment is such that the difference between the contact patch length at center land portion 4 and the contact patch length at side land portion 5 has almost completely disappeared. This being the case, because there will be an increase in the size of the region that comes in contact with the ground at side land portion 5, there will be a tendency for contact patch pressure to be distributed from center land portion 4 toward side land portion 5.

Accordingly, because the difference between the contact patch pressure at center land portion 4 and the contact patch pressure at side land portion 5 is reduced, it is possible for contact patch pressure to be made uniform in the tire width direction D1. At FIG. 8, note that the surface shape that comes in contact with the road surface at the tire associated with the comparative embodiment is shown in broken line.

It so happens that when tire 1 comes in contact with the ground, there is ordinarily an increasing tendency for land portions 4 through 6 to deform so as to become compressed as one proceeds toward locations intermediate in the tire width direction D1. For this reason, because there is, for example, a tendency for buckling to occur at locations intermediate in the tire width direction D1 of land portions 4 through 6, there is a tendency for locations (e.g., central locations) intermediate in the tire width direction D1 of land portions 4 through 6 not to come in contact with the ground. Accordingly, when land portions 4 through 6 are each viewed individually, there is a tendency for contact patch pressure to be nonuniform in the tire width direction D1.

At tire 1 associated with the present embodiment, protruding amounts W42 through W62 of protruding regions 42 through 62 are therefore made to decrease as one proceeds from peaks 43 through 63, which are arranged at locations intermediate in the tire width direction D1, toward the ends in the tire width direction D1 of land portions 4 through 6. This makes it possible for locations intermediate in the tire width direction D1 of land portions 4 through 6 to definitively come in contact with the ground. Accordingly, it is possible to cause contact patch pressure to be made uniform in the tire width direction D1 not only when tire 1 is viewed as a whole but also when land portions 4 through 6 are each viewed individually.

Causing land portions 4 through 6 to comprise protruding regions 42 through 62 thus makes it possible to cause contact patch pressure to be made uniform in the tire width direction D1. On the other hand, causing land portions 4 through 6 to comprise protruding regions 42 through 62 also increases the volume of rubber at tire 1 due to presence of protruding regions 42 through 62. Because this increases the weight of the rubber at tire 1, there is a concern that there could be an increase in rolling resistance.

At tire 1 associated with the present embodiment, dimension W5 in the tire width direction D1 of side land portion 5 is therefore made less than dimension W4 in the tire width direction D1 of center land portion 4. By so doing, it is possible to suppress increase in the weight of the rubber at side protruding region 52 despite the fact that the amount W52 by which side protruding region 52 protrudes is made large. Accordingly, it will be possible to cause contact patch pressure to be made uniform in the tire width direction D1 and at the same time suppress increase in rolling resistance.

As described above, the pneumatic tire 1 of the embodiment includes: a plurality of main grooves 3a, 3b extending in a tire circumferential direction D3; and a plurality of land portions 4 through 6 that are partitioned by at least one contact patch end 2b, 2c and the plurality of main grooves 3a, 3b; wherein the plurality of land portions 4 through 6 comprise a center land portion 4 that contains a center in a tire width direction D1, and a pair of side land portions 5, 5 that are adjacent in the tire width direction D1 to the center land portion 4; and wherein respective maximum values of amounts W52, W52 by which the pair of side land portions 5, 5 protrude from a tread profile S2 are each greater than a maximum value of an amount W42 by which the center land portion 4 protrudes from the tread profile S2.

In accordance with such constitution, the maximum value of the amounts W52, W52 by which the pair of side land portions 5, 5 protrude is greater than the maximum value of the amount W42 by which center land portion 4 protrudes. This makes it possible to increase the sizes of the regions at which the pair of side land portions 5, 5 make contact with the ground. Accordingly, because there will be a tendency for contact patch pressure to be distributed from center land portion 4 toward side land portion 5, the difference between the contact patch pressure at center land portion 4 and the contact patch pressure at side land portion 5 will be reduced. It will therefore be possible to cause contact patch pressure to be made uniform in the tire width direction D1.

In the pneumatic tire 1 of the embodiment, respective average values of the amounts W52, W52 by which the side land portions 5, 5 protrude are each greater than an average value of the amount W42 by which the center land portion 4 protrudes.

In accordance with such constitution, because there is even further increase in the size of the region that comes in contact with the ground at side land portion 5, there will be even more of a tendency for contact patch pressure to be distributed from center land portion 4 toward side land portion 5. As a result, because the difference between the contact patch pressure at center land portion 4 and the contact patch pressure at side land portion 5 will be even further reduced, it will be possible for contact patch pressure to be made even more uniform in the tire width direction D1.

In the pneumatic tire 1 of the embodiment, a void fraction of the center land portion 4 is greater than respective void fractions of each of the side land portions 5, 5.

In accordance with such constitution, because the void fraction at center land portions 4 is high, rigidity of center land portion 4 is low. As a result, when center land portion 4 comes in contact with the ground, center land portion 4 will more readily undergo compressive deformation in the tire radial direction D2. Accordingly, because there will be a greater tendency for side land portion 5 to come in contact with the ground, the size of the region at which side land portion 5 makes contact with the ground will increase.

As a result, because there will be a tendency for contact patch pressure to be distributed from center land portion 4 toward side land portion 5, the difference between the contact patch pressure at center land portion 4 and the contact patch pressure at side land portion 5 will be reduced. It will therefore be possible to cause contact patch pressure to be made uniform in the tire width direction D1.

In the pneumatic tire 1 of the embodiment, the amount W52 by which at least one of the side land portions 5 protrudes decreases as one proceeds from a location intermediate in the tire width direction D1 of the at least one side land portion 5 toward either end in the tire width direction D1 of the at least one side land portion 5.

In accordance with such constitution, to address the fact that there is a general tendency for locations intermediate in the tire width direction D1 of side land portion 5 not to come in contact with the ground when side land portion 5 comes in contact with the ground and deforms, locations intermediate in the tire width direction D1 of side land portion 5 can be made to definitively come in contact with the ground. As a result, it is possible to cause contact patch pressure to be made uniform in the tire width direction D1 not only across tire 1 as a whole but also across each of the side land portions 5.

In the pneumatic tire 1 of the embodiment, a dimension W5, W5 in the tire width direction D1 of each of the side land portions 5, 5 is less than a dimension W4 in the tire width direction D1 of the center land portion 4.

In accordance with such constitution, it is possible to suppress increase in the weight of the rubber at side land portion 5 despite the fact that the amount W52 by which side land portion 5 protrudes is made large. As a result, it is possible to cause contact patch pressure to be made uniform in the tire width direction D1 and yet at the same time suppress increase in rolling resistance.

The pneumatic tire 1 is not limited to the configuration of the embodiment described above, and the effects are not limited to those described above. It goes without saying that the pneumatic tire 1 can be variously modified without departing from the scope of the subject matter of the present invention. For example, the constituents, methods, and the like of various modified examples described below may be arbitrarily selected and employed as the constituents, methods, and the like of the embodiments described above, as a matter of course.

(1) The constitution of pneumatic tire 1 associated with the foregoing embodiment is such that the number of main grooves 3a, 3b that are present is four. However, pneumatic tire 1 is not limited to such constitution. For example, it is also possible to adopt a constitution in which the number of main grooves 3a, 3b that are present is three or is five or more, and as shown in FIG. 9 it is also possible to adopt a constitution in which the number of main grooves 3a that are present is two.

At tire 1 associated with FIG. 9, the maximum value of the amount W52 by which side protruding region 52 protrudes is greater than the maximum value of the amount W42 by which central protruding region 42 protrudes. Furthermore, the average value of the amount W52 by which side protruding region 52 protrudes is greater than the average value of the amount W42 by which central protruding region 42 protrudes.

In addition, the amount W52 by which side protruding region 52 protrudes decreases as one proceeds from a location intermediate in the tire width direction D1 of side land portion 5 toward either end in the tire width direction D1 of side land portion 5. Moreover, dimension W5 in the tire width direction D1 of side land portion 5 is less than dimension W4 in the tire width direction D1 of center land portion 4.

(2) Furthermore, the constitution of pneumatic tire 1 associated with the foregoing embodiment is such that center land portion 4 comprises protruding region 42. However, pneumatic tire 1 is not limited to such constitution. For example, it is also possible to adopt a constitution in which center land portion 4 does not comprise a protruding region 42. That is, it is also possible to adopt a constitution in which the maximum value of the amount W42 by which center land portion 4 protrudes from tread profile S2 is zero.

(3) Furthermore, the constitution of pneumatic tire 1 associated with the foregoing embodiment is such that shoulder land portion 6 comprises protruding region 62. However, pneumatic tire 1 is not limited to such constitution. For example, it is also possible to adopt a constitution in which shoulder land portion 6 does not comprise a protruding region 62. That is, it is also possible to adopt a constitution in which the maximum value of the amount W62 by which shoulder land portion 6 protrudes from tread profile S2 is zero.

(4) Furthermore, the constitution of pneumatic tire 1 associated with the foregoing embodiment is such that the average value of the amount W52 by which side protruding region 52 protrudes is greater than the average value of the amount W42 by which central protruding region 42 protrudes. However, while such constitution is preferred, pneumatic tire 1 is not limited to such constitution. For example, it is also possible to adopt a constitution in which the average value of the amount W52 by which side protruding region 52 protrudes is less than or equal to the average value of the amount W42 by which central protruding region 42 protrudes.

(5) Furthermore, the constitution of pneumatic tire 1 associated with the foregoing embodiment is such that the void fraction at center land portion 4 is greater than the void fraction at side land portion 5. However, while such constitution is preferred, pneumatic tire 1 is not limited to such constitution. For example, it is also possible to adopt a constitution in which the void fraction at center land portion 4 is less than or equal to the void fraction at side land portion 5.

(6) Furthermore, the constitution of pneumatic tire 1 associated with the foregoing embodiment is such that protruding amounts W42 through W62 of protruding regions 42 through 62 decrease as one proceeds from a location intermediate in the tire width direction D1 of each of land portions 4 through 6 toward the respective ends in the tire width direction D1 of each of land portions 4 through 6. However, while such constitution is preferred, pneumatic tire 1 is not limited to such constitution.

For example, it is also possible to adopt a constitution in which protruding amounts W42 through W62 of protruding regions 42 through 62 are the same at all locations in the tire width direction D1 of land portions 4 through 6. Furthermore, it is also possible, for example, to adopt a constitution in which protruding amount W42 through W62 of protruding region 42 through 62 decreases as one proceeds from one end to the other end in the tire width direction D1 of land portion 4 through 6.

(7) Furthermore, the constitution of pneumatic tire 1 associated with the foregoing embodiment is such that dimension W5 in the tire width direction D1 of side land portion 5 is less than dimension W4 in the tire width direction D1 of center land portion 4. However, while such constitution is preferred, pneumatic tire 1 is not limited to such constitution. For example, it is also possible to adopt a constitution in which dimension W5 in the tire width direction D1 of side land portion 5 is greater than or equal to dimension W4 in the tire width direction D1 of center land portion 4.

(8) Furthermore, the constitution of pneumatic tire 1 associated with the foregoing embodiment is such that, when land portion 4 through 6 is divided into three equal regions in the tire width direction D1, peak 43 through 63 of protruding region 42 through 62 is arranged at a location that is in the central region thereamong. However, pneumatic tire 1 is not limited to such constitution. For example, it is also possible to adopt a constitution in which, when land portion 4 through 6 is divided into three equal regions in the tire width direction D1, peak 43 through 63 of protruding region 42 through 62 is arranged at a location that is in the region thereamong which is toward the exterior in the tire width direction D1.

1. A pneumatic tire comprising:
a plurality of main grooves extending in a tire circumferential direction; and
a plurality of land portions that are partitioned by at least one contact patch end and the plurality of main grooves;
wherein the plurality of land portions comprise a center land portion that contains a center in a tire width direction, and a pair of side land portions that are adjacent in the tire width direction to the center land portion; and
wherein respective maximum values of amounts by which the pair of side land portions protrude from a tread profile are each greater than a maximum value of an amount by which the center land portion protrudes from the tread profile.

2. The pneumatic tire according to claim 1 wherein respective average values of the amounts by which the side land portions protrude are each greater than an average value of the amount by which the center land portion protrudes.

3. The pneumatic tire according to claim 1 wherein a void fraction of the center land portion is greater than respective void fractions of each of the side land portions.

4. The pneumatic tire according to claim 1 wherein the amount by which at least one of the side land portions protrudes decreases as one proceeds from a location intermediate in the tire width direction of the at least one side land portion toward either end in the tire width direction of the at least one side land portion.

5. The pneumatic tire according to claim 1 wherein
at least one of the side land portions comprises a protruding region that protrudes from the tread profile;
the protruding region comprises a peak at which an amount of protrusion from the tread profile is a maximum;
at least one side land portion is divided in the tire width direction into three equal regions including a central region; and
the peak is arranged in the central region.

6. The pneumatic tire according to claim 1 wherein a dimension in the tire width direction of each of the side land portions is less than a dimension in the tire width direction of the center land portion.

7. The pneumatic tire according to claim 1 wherein
there are four of the main grooves;
the plurality of land portions comprise a pair of shoulder land portions arranged in outwardmost fashion in the tire width direction; and
a maximum value of an amounts by which each of the pair of side land portions protrudes from the tread profile is greater than a maximum value of an amount by which each of the pair of shoulder land portions protrudes from the tread profile.

8. The pneumatic tire according to claim 7 wherein a dimension in the tire width direction of each of the side land portions is less than a dimension in the tire width direction of each of the shoulder land portions.
